(19) United States
(12) Patent Application Publication
(10) Pub. No.: US 2013/0298789 A1
(43) Pub. Date: Nov. 14, 2013

(54) ROLLER STAMP

(71) Applicant: PLUS CORPORATION, Minato-ku (JP)

(72) Inventors: Shoichi Soma, Minato-ku (JP); Hideyuki Kitamura, Minato-ku (JP)

(73) Assignee: PLUS Corporation, Minato-ku (JP)

(21) Appl. No.: 13/759,814

(22) Filed: Feb. 5, 2013

(30) Foreign Application Priority Data
May 11, 2012 (JP) 2012-109180

(51) Int. Cl. B41F 17/00

(52) U.S. Cl. CPC B41F 17/006
USPC 101/375

(57) ABSTRACT

Disclosed is a roller stamp with a stamp face roller that configures a stamp face, an inner case that fixes the roller with the ability to rotate, an outer case that fixes the inner case on one end and that configures a handgrip, a cap that tightly seals the roller, and a volatile ink that is impregnated on the stamp face of the roller. The disclosed roller stamp can stamp on even a coated paper that does not allow permeation by an ink solvent.

### CROSS REFERENCE TO RELATED APPLICATION

This application claims priority to and the benefit of Japanese Patent Application No. 2012-109180, filed May 11, 2012, in the Japan Patent Office, the disclosure of which is incorporated herein by reference in its entirety.

### FIELD

This disclosure relates to a roller stamp, and particularly relates to a stamp that can also stamp on paper having a surface coating that does not absorb ink solvent.

### BACKGROUND

Medicine containers, such as cylindrical containers that store medicine provided from a hospital or the like are labeled with a person's name, name of a disease, name of a medicine, and the like.

The label on the container is a coated paper that does not absorb ink solvent.

There has been demand to conceal the person's name and the name of a disease listed on the label when disposing the used container after the medicine is used up.

There have been products designed to conceal personal information by imprinting with an ink solvent a pattern on the writing on a label where the personal information is listed by transferring a pattern existing on a stamp face onto the label with a permeating ink solvent.

However, these products do not perform sufficiently on medicine bottles. A conventional stamp cannot conceal the personal information on the coated paper used on a medicine bottle because the ink solvent used is repelled without permeating the label.

Moreover, conventional devices, such as that described in Japanese Unexamined Patent Application Publication No. 2011-143624, do not seal sufficiently when not in use. In addition the device of Japanese Unexamined Patent Application Publication No. 2011-143624 will not work to transfer a pattern to coated paper, as volatile ink such as that used for coated paper that does not absorb the disclosed ink solvent. Further, the device disclosed in Japanese Unexamined Patent Application Publication No. 2011-143624 is too large to effectively stamp on a label that has been pasted to the surface of a cylindrical medicine case.

### SUMMARY

Disclosed herein is a roller stamp provided with a stamp face roller that configures a stamp face, an inner case that fixes the roller with the ability to rotate, an outer case that fixes the inner case on one end and that configures a handgrip, a cap that tightly seals the roller, and a volatile ink that is impregnated on the stamp face of the roller. The disclosed roller stamp can stamp on even a coated paper that does not allow permeation by an ink solvent.

Further, the disclosed roller stamp can easily stamp on a label or the like that is pasted on the surface of a cylindrical container.

Particularly, in some embodiments, the disclosed roller stamp includes a volatile ink usable on a roller stamp by having a structure such that a stamp face can be kept in firmly sealed state when not in use so as to reduce the evaporation of the volatile ink impregnated on the stamp face.

### BRIEF DESCRIPTION OF THE DRAWINGS

FIG. 1 is a perspective view illustrating a basic configuration according to a mode of an embodiment of the disclosed roller stamp;

FIG. 2 is a cross-sectional view showing a joined state of a roller stamp main body and a cap according to a mode of an embodiment of the disclosed roller stamp;

FIG. 3 is a top view according to a mode of an embodiment of the disclosed roller stamp;

FIG. 4 is an explanatory drawing illustrating use of the disclosed roller stamp; and

FIG. 5 is a perspective view illustrating another embodiment of the disclosed roller stamp.

### DETAILED DESRIPTION

Disclosed herein is a roller stamp provided with a stamp face roller that configures a stamp face, an inner case that fixes the roller with the ability to rotate, an outer case that fixes the inner case on one end and that configures a handgrip, a cap that tightly seals the roller, and a volatile ink that is impregnated on the stamp face of the roller.

Further, in certain embodiments, the other end of the outer case forms a substantially oval shaped top face and configures a substantially flat part on the side surface.

Furthermore, in certain embodiments, the cap is configured with an inner cap part that is inserted within the inner case and configures a sealed space, and with an outer cap part for opening and closing the cap.

Moreover, in some embodiments, a groove is formed in an outer peripheral sidewall of the inner case, and a projection is provided on the inner cap part that enters into the groove and is fixed at the end part of the groove.

The disclosed roller stamp can stamp on a coated paper that does not allow permeation by an ink solvent, and particularly can easily stamp on a label or the like that is pasted on a surface of a medicine storing case or container having a cylindrical form.

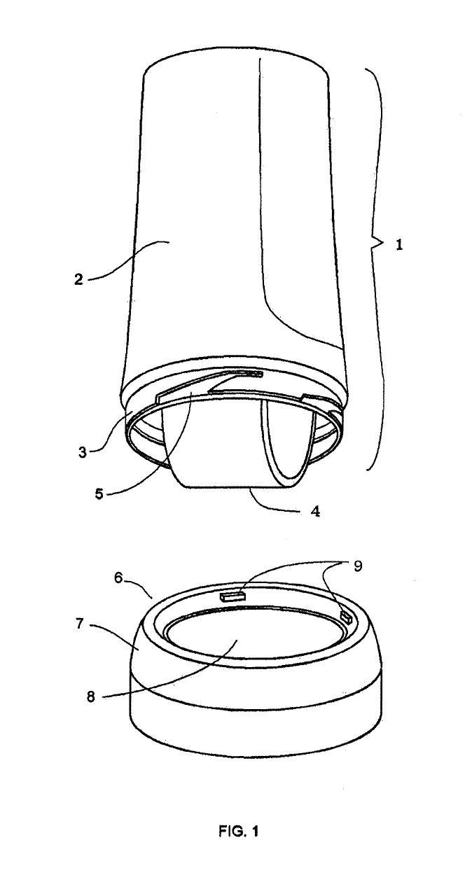

In an embodiment, and with reference to FIG. 1, a roller stamp main body 1 is configured of an outer case 2 that configures a handgrip and an inner case 3 of a cylindrical shape that holds a stamp face roller 4 with the ability to rotate that configures the stamp face.

The stamp face of the stamp face roller 4 is made of a foam resin material, such as a polyethylene, polypropylene and/or polyurethane, and a volatile ink is impregnated into the resin material.

Cap 6 configured of an inner cap part 8 of a dome shape in which a circular shape opening end is entered within the inner case 3 to keep the stamp face roller 4 sealed, and an outer cap part 7 of a cylindrical shape is configured to form a handgrip in order to access the cap 6.

A groove 5 is formed on an outer peripheral sidewall of the inner case 3 having a shape that gradually narrows from one end with a wide width and becomes parallel to the circumferential direction of the inner case 3 on the other end, and a projection 9 that enters on one end of the groove 5 and is fixed by the other end part of the groove 5 provided on the inner side of the sidewall of the outer cap part 6.

In the disclosed embodiment, four projections 9 and grooves 5 are, respectively, provided along the circumferential direction of the inner case 3 and outer cap part 7 (only 2 can be seen in FIG. 1), though more or fewer groves could be present in an embodiment.

Because one end of the groove 5 is formed with a wider width than the horizontal width of the projection 9, the projection 9 of the outer cap 7 can be inserted easily into the groove 5 of the inner case 3. Further, because the width of the vertical direction of the other end of the groove 5 is formed in the same size as the width of the vertical direction of the projection 9, the cap 6 is firmly fixed when the projections engage the narrower end of groove 5 so that it is not easily removable. Firmly fixing the cap reduces evaporation of the volatile ink.

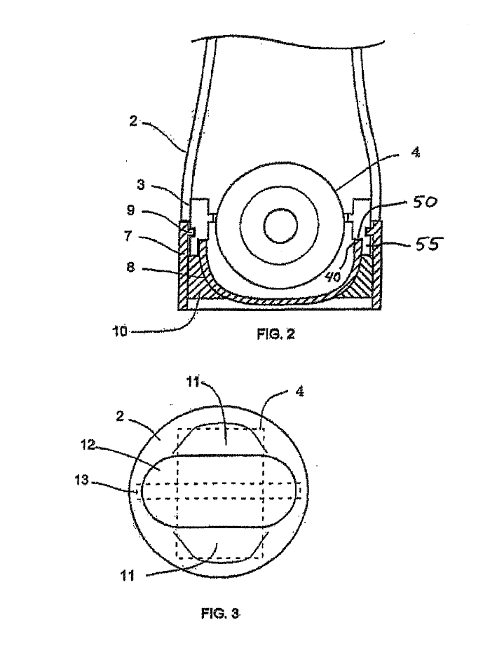

The outer cap part 7 and the inner cap part 8 of the cap 6 are connected by a bridge part 10, as shown in FIG. 2.

The stamp face roller 4 shown in FIG. 1 can be kept sealed by having the circular shaped opening end of the inner cap part 8 joined to groove 5 provided on the outer peripheral sidewall of the inner case 3.

The inner cap part 8 is formed in a dome shape and not in a regular hexahedron shape in order to make the sealed space small.

The stamp face roller 4 shown in FIG. 1 is composed of a foam resin material having micro pores. A volatile ink is impregnated in the micro pores of the stamp face roller 4. In disclosed embodiment, ink is used comprising 70 wt % to 80 wt % of dipropylene glycol monomethyl ether that is a volatile solvent, 9 wt % to 11 wt % of a pigment carbon black, and 10 wt % to 20 wt % of a binder resin (which is a cellulose soluble in dipropylene glycol monoethyl ether, and used as a film forming component to impart adhesion between the ink and the substrate to which it is applied) such as polyvinyl butyral resin, phenol resin, alkyl phenol resin, and ketonic acid resinall blended together. In a further embodiment a volatile black ink is used comprising 80 wt % of dipropylene glycol monoethyl ether, 10 wt % of Mitsubishi carbon black #30, 5 wt % of polyvinyl butyral resin, and 5 wt % of ketonic acid resin. The ink in this further embodiment has a 600 milipascal-second at 20° C. and 30 rpm rotation speed, whereas the vapor pressure of dipropylene glycol monomethyl ether is 0.08 hectopascal at 20° C. The ink often used in inkjet printer solidifies rapidly in about less than 1 second, with the vapor pressure of dipropylene glycol monoethyl ether being as high as about 8 hectopascal at 20° C., as opposed to slow solidifying ink with the vapor pressure as low as 0.05 hectopascal at 20° C.

Dipropylene glycol monomethyl ether that is a volatile solution is used, for example, for ink in ink-jet printers. However, the formula often used in the ink of ink jet printer solidifies too rapidly to allow for use with the disclosed roller stamp. Accordingly, the blending of the ink used with the disclosed roller stamp is adjusted so that the ink will remain in a flowing form for a sufficient amount of time before becoming volatilized and solidified. The formula disclosed above is an embodiment of such ink.

Although the volatile ink used in the disclosed embodiments should not dry too quickly, when compared to a conventional stamp, the ink of the present disclosure dries and solidifies on a stamp face in a relatively short period of time, such as about 3 minutes, for example 3 to 10 minutes. Therefore, the cap 6 uses the structure as described above in order to maintain a high sealed level by the cap 6 when the roller stamp is not in use. A high seal level is desirable to reduce evaporation of the volatile ink.

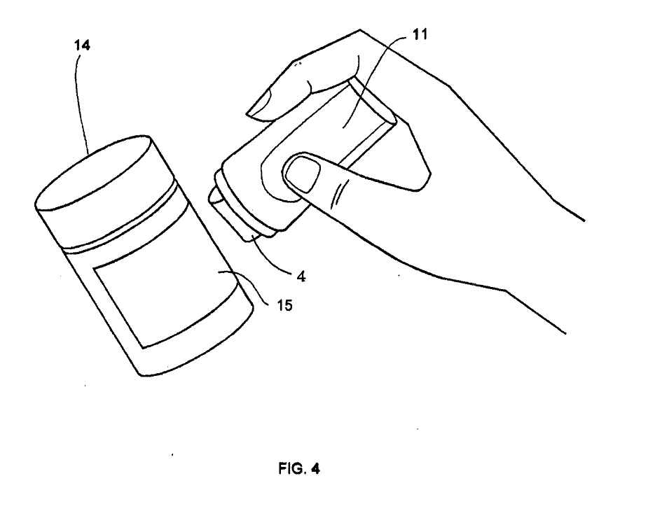

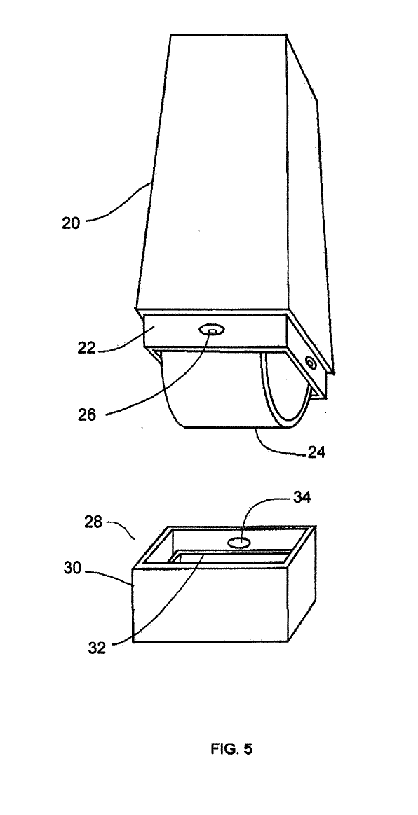

With reference to FIG. 3, in outer case 2, a top face 12 is configured in a substantially oval or a capsule shape so that at least two side surfaces of outer case 2 that correspond to the long sides of the oval shape are substantially flat. This can also be seen in FIG. 1 and in FIG. 4 at 11. This makes the disclosed roller stamp easy to hold for use as shown in FIG. 4.

However, with reference to FIG. 3 and FIG. 4, the side surfaces of the outer case 2 are configured in a streamlined shape so as to gradually transition from an oval shape at the top face part 12 of the outer case 2 to a circular shape near the bottom of the outer case 2 while maintaining the flat part 11 downward from the top face part 12.

The two flat parts 11 are provided symmetrically in parallel to a rotational axis 13 of the stamp face roller 4 as shown in FIG. 3.

FIG. 4 shows an example of how the roller stamp might be used by applying the stamp onto a label 15 pasted on the surface of a medicine case 14. Because the flat part 11 is provided in parallel parts to the rotational axis 13 (shown in FIG. 3) of the stamp face roller 4, when a user holds the device by placing a thumb at the flat part 11, the rotational axis of the stamp face roller 4 is substantially parallel to the center axis of the cylindrical shape of the medicine case 14, and therefore the user can easily press the stamp onto the label 15.

In this disclosed embodiment, and with reference to FIGS. 1 and 2, the device has a structure in which outer case 2 and inner case 3 are fixed together by press fitting the inner case 3 into the outer case 2. In such configuration, the stamp face roller 4 is non-removable from the inner case.

With reference to FIG. 1, the stamp face of the stamp face roller 4 may comprise an engraved pattern in which alphabets are arranged randomly so that the device will transfer the pattern and cause reading to become difficult in the area where the stamp face is pressed.

In other embodiments the stamp face may be engraved with a different pattern, such as with an individual's name, a company name, letters indicating confidential, or any other pattern.

Further, an embodiment of the disclosed roller stamp has a horizontal width across the oval portion of the top face 12 of 2 cm or less for use in pressing on the label of a medicine case.

The cap 6 may have a diameter that is 4 cm or less, such as about 3½ centimeters, across the end distal from the projections.

In an embodiment, the roller stamp comprising combination of the stamp main body 1 and cap 6 shown in FIG. 1 has a vertical length that is 8 cm or less, for example about 6½ centimeters. Such an embodiment allows for easy carrying and manipulation of the roller stamp.

The invention disclosed is not limited to the embodiments described above, and for example, the size of the roller stamp may be larger or smaller than the embodiment described above.

Further, the external form of the roller stamp is also not limited to the disclosed embodiments.

Furthermore, the cap structure and the attachment structure may also be modified in various ways.

For example, as illustrated in FIG. 5, the external form may be substantially a rectangular parallelepiped shape. In this embodiment, outer case 20 and inner case 22 are both rectangular. As is cap 28 and corresponding outer cap part 30.

In an embodiment, such as is shown in FIG. 5, an outer case 20 is shown into which fits inner case 22 the cap 28 is not attached by winding along a groove 5 as shown in FIG. 1. Instead, in such an embodiment, a spherical shaped projection 34 provided in the outer cap part 30 of the cap 28 is attached by pushing straight into a corresponding dome shaped groove 26 until fitted. Stamp surface roller 24 is held by inner case 22.

1. A roller stamp, comprising:
an outer case configured as that fixes the inner case on one end and that configures a handgrip;
an inner case mounted in the outer case;
a roller rotatably connected to the inner case and including a rolling stamp face, wherein the rolling stamp face is configured to be impregnated with a volatile ink; and
a cap configured to tightly seal the roller.

2. The roller stamp of claim 1, wherein the inner case is mounted in the outer case at a first end of the outer case, and wherein a second end of the outer case forms the handgrip having a substantially oval shaped top face.

3. The roller stamp of claim 1, wherein the cap comprises:
an inner cap part that is inserted within the inner case to seal the roller; and
an outer cap part for opening and closing the cap.

4. The roller stamp of claim 3, wherein a groove is formed in an outer peripheral sidewall of the inner case, and wherein a projection is provided on the inner cap part that enters into the groove and fixes the cap to the inner case when the cap is rotated about the inner case.

5. The roller stamp of claim 1, wherein the rolling stamp face comprises an engraved pattern in which characters are arranged randomly.

6. The roller stamp of claim 1, wherein the inner case is press fit into the outer case to prevent the inner case from being removed during usage of the roller stamp.

7. The roller stamp of claim 1, wherein the roller has a horizontal width of 2 cm or less as measured along a rotational axis of the roller.

8. The roller stamp of claim 2, wherein the first end of the outer case has a diameter of 4 cm or less, and wherein the outer case has a vertical length of 8 cm or less.

9. The roller stamp of claim 1, wherein the volatile ink comprises dipropylene glycol monomethyl ether.

10. The roller stamp of claim 9, wherein the volatile ink comprises 9 wt % to 11 wt % of a pigment carbon black.

11. The roller stamp of claim 2, wherein the handgrip comprises two flat surfaces located on either side of the outer case, and wherein the two flat surfaces are substantially parallel to a rotational axis of the roller.

12. The roller stamp of claim 3, wherein the inner cap is formed in a dome shape to receive the roller, and wherein the outer cap is formed in a cylindrical shape.

13. The roller stamp of claim 12, wherein the inner cap and the outer cap are rigidly connected to each other by one or more bridges.

14. The roller stamp of claim 12, wherein the inner case comprises a peripheral sidewall with a step, and wherein a circular shaped opening end of the dome shaped inner cap is joined to the step when the inner cap is inserted within the peripheral sidewall.

15. The roller stamp of claim 4, wherein the inner cap part comprises four projections that are configured to enter into four respective grooves of the peripheral sidewall of the inner case.

16. The roller stamp of claim 4, wherein the groove gradually narrows from an entry point of the projection and becomes parallel to a circumferential direction of the inner case at a narrowed portion of the groove.

17. The roller stamp of claim 16, wherein the entry point has a width that is larger than a width of the projection, and wherein a width of the narrowed portion of the groove is of an approximate same size as the width of the projection.

18. The roller stamp of claim 17, wherein the projection is configured to enter into the narrowed portion of the groove when the cap is rotated about the inner case.

19. The roller stamp of claim 3, wherein the outer cap part is located outside of the inner case when the inner cap is inserted within the inner case.

20. The roller stamp of claim 3, wherein the inner cap part comprises a dome shape that is configured to form a sealed space about the roller.
